(19) United States
(12) Patent Application Publication
(10) Pub. No.: US 2017/0169445 A1
(43) Pub. Date: Jun. 15, 2017

(54) METHOD AND SYSTEM FOR DETERMINING LIKELIHOOD OF CHARITY CONTRIBUTION

(71) Applicant: MasterCard International Incorporated, Purchase, NY (US)

(72) Inventors: Randall Shuken, Westport, CT (US); Manash Bhattacharjee, Jersey City, NJ (US); Debashis Ghosh, Charlotte, NC (US)

(21) Appl. No.: 14/964,660

(22) Filed: Dec. 10, 2015

(51) Int. Cl. G06Q 30/02; G06Q 20/10

(52) U.S. Cl. CPC G06Q 30/0202; G06Q 30/0279; G06Q 20/10

(57) ABSTRACT

A method is provided for determining the propensity of candidate donors to donate to one or more charities. The method generally includes identifying, using a computing processing unit, transactions processed over at least one payment device network as being associated with a first candidate donor. The identified transactions are then parsed to extract ISO 8583 formatted data. By evaluating the extracted ISO 8583 formatted data, a propensity score is assigned to the first candidate donor where the propensity score represents the propensity of the first candidate donor to donate to a first predefined charity, with the propensity score being indicative of likelihood that the first candidate donor will donate to the first predefined charity.

### FIELD OF THE INVENTION

The present invention relates to methods and systems for determining charitable contribution propensity, and more particularly, to methods and systems for determining charitable contribution propensity of candidate donors to donate to charities.

### BACKGROUND OF THE INVENTION

As the number of nonprofit organizations increases and potential donors have numerous charities that they can support, success of most, if not all, of the charities depend on maintaining existing donors and attracting new donors (individuals or corporations). However, currently, many nonprofit organizations are struggling to attract new donors to grow their donation amounts. One of the main reasons for the struggle may be that charitable organization personnel who are responsible for developing effective donation campaigns may not have access to information allowing them to identify potential donors.

Another possible reason is that most of the charities may not have the resources to develop effective targeting strategies to attract particular donors, but rather, simply use conventional blanket fundraising strategies that are minimally effective or not effective at all. For example, “cold-calling” or “cold-mailing” every existing donor or potential donor to solicit donations rarely produces a desirable result of receiving donations. In fact, these “cold-calling” and “cold-mailing” approaches may turn potential donors off from ever contributing in the future. Thus, in order to operate a successful charity, effective market strategies must be implemented to attract new donors and/or to maintain existing donors. However, strategizing and developing effective strategies to raise donations occupies valuable resources such as time, energy and money.

### SUMMARY OF THE INVENTION

According to an embodiment of the present invention, a method for determining the propensity of candidate donors to donate to one or more charities includes operatively linking a computing processing unit to at least one payment device network; operatively linking an electronic memory to the computing processing unit; identifying, using the computing processing unit, transactions processed over the at least one payment device network as being associated with a first candidate donor; storing the identified transactions on the electronic memory; parsing the identified transactions to extract ISO 8583 formatted data, the ISO 8583 formatted data representing, where present, for each of the identified transactions, an associated merchant category code, an associated merchant name, and an associated transaction amount; determining, for each of the identified transactions, where the associated merchant category code is present, if the associated merchant category code is associated with a first predefined charity to establish the respective identified transaction as being associated with the first predefined charity; determining, for each of the identified transactions, where the associated merchant name is present, if the associated merchant name is associated with the first predefined charity to establish the respective identified transaction as being associated with the first predefined charity; aggregating the associated transaction amounts for the identified transactions for the first candidate donor associated with the first predefined charity; aggregating the associated transaction amounts for the identified transactions for the first candidate donor; and assigning a propensity score to the first candidate donor based on the aggregated associated transaction amounts associated with the first predefined charity relative to the aggregated associated transaction amounts for the first candidate donor, the propensity score representing the propensity of the first candidate donor to donate to the first predefined charity.

A system for determining the propensity of candidate donors to donate to one or more charities includes one or more computing processing units (CPUs), an electronic memory, one or more database management systems, and an interface. The one or more computing processing units are configured to monitor financial transactions being transmitted over one or more payment device networks and to execute a plurality of logistic regression models. The electronic memory is linked to the one or more computing processing units. Each of the one or more database management systems includes a user account database, a transaction database and a charity propensity database. The user account database is configured to store data associated with account holders, including participating account holders and participating charities. The transaction database is configured to store financial transactions identified by the one or more computing processing units, the identified financial transaction including past purchase details and past charitable contribution details. The charity propensity database is configured to store data structures corresponding to a propensity profile, including propensity scores, for each of the account holders. The interface is configured to communicate between the participants and the one or more computing processing units.

These and other aspects of the present invention will be better understood in view of the drawings and following detailed description.

### BRIEF DESCRIPTION OF THE DRAWINGS

FIG. 1 illustrates schematically the process and parties typically involved in consummating a cashless transaction;

FIG. 2 is a block diagram of a system, according to an embodiment of the present invention;

FIG. 3 is a block diagram of the system, according to an embodiment of the present invention, integrated with a payment device network;

FIG. 4 is a flowchart of a method for generating propensity profiles, including propensity scores, according to the present invention;

FIG. 5 illustrates an exemplary list of candidate donors provided to a participating charity according to the present invention;

FIG. 6 illustrates an exemplary credit card statement of a participating account holder;

FIG. 7 illustrates an exemplary credit card statement of another account holder;

FIG. 8 illustrates exemplary credit card statement of yet another account holder; and

FIG. 9 illustrates an exemplary list of suggested charities provided to a participating account holder according to the present invention.

### DETAILED DESCRIPTION

The following sections describe exemplary embodiments of the present disclosure. It should be apparent to those skilled in the art that the described embodiments of the present disclosure are illustrative only and not limiting, having been presented by way of example only. All features disclosed in this description may be replaced by alternative features serving the same or similar purpose, unless expressly stated otherwise. Therefore, numerous other embodiments of the modification thereof are contemplated as falling within the scope of the present disclosure as defined herein and equivalents thereto.

Throughout the description, where items are described as having, including, or comprising one or more specific components, or where methods are described as having, including, or comprising one or more specific steps, it is contemplated that, additionally, there are items of the present disclosure that consist essentially of, or consist of, the one or more recited components, and that there are methods according to the present disclosure that consist essentially of, or consist of, the one or more recited processing steps.

The present disclosure is described below with reference to flowchart illustrations and/or block diagrams of methods, apparatuses (systems), and computer program products according to embodiments of the disclosure. It will be understood that each block of the flowchart illustrations and/or block diagrams, and combinations of blocks in the flowchart illustrations and/or block diagrams, may be implemented by computer program instructions.

Providing of such computer program instructions to the “server,” “device,” “computing device,” “general purpose computer,” “computer device,” “system,” or “specialized computing device” causes a machine to be produced, such that the computer program instructions when executed create means for implementing the functions/acts specified in the flowchart and/or block diagram block or blocks. These computer program instructions may also be stored in a computer-readable medium that may direct a computer or other programmable data processing apparatus to function in a particular manner, such that the instructions stored in the computer-readable medium produce an article of manufacture including instruction means which implement the function/act specified in the flowchart and/or block diagram block or blocks.

The present invention is not necessarily limited to any particular number, type or configuration of processors, nor to any particular programming language, memory storage format or memory storage medium.

As used herein, a “payment device network” refers to a network or system such as the systems operated by MasterCard International Incorporated, or other networks, which electronically process payment transactions on behalf of merchants, acquirers, issuers and cardholders. The payment device network acts as an intermediary between these parties, such as between acquirers and issuers. The payment device network may include a network of operatively linked computer processing units (CPUs). The payment network is not accessible by the general public.

As used herein, “financial transactions” refers to all debit and credit transactions, including, but not limited to, those based on payment devices, fobs (or other near-field-communication (NFC) devices), cellular phones, smartphones, and web-enabled systems.

As used herein, a “predefined charity” refers to either a charity or a charity category. For example, a predefined charity may be the “American Red Cross” (charity) or “Education” (charity category).

As used herein, an “account holder” refers to an owner of one or more accounts (credit card, debit, etc.) which are processed over payment device network. The account holder is responsible for maintaining his/her accounts.

The subject invention involves collecting and analyzing details at an individual consumer level based on information collected over a payment device network. The system of the subject invention may be utilized to monitor purchases and/or charitable contributions of the consumer to evaluate propensity to donate to particular charities. It is noted that any form of payment over a payment device network may be utilized within the system. The monitoring and evaluation of the consumer may be conducted in real-time to incorporate latest activities.

The subject invention utilizes information that is embedded in the financial transactions, e.g., in ISO 8583 format. The subject invention, therefore, may be implemented with a system that is operatively connected to one or more payment device networks, with little or no modification of the respective payment device networks.

The process described and depicted herein requires that charities and/or account holders to affirmatively enroll in a charitable contribution propensity program offered by a payment device network operator. Enrollment may include a request to enroll by a charity or an account holder, and an acceptance by the payment device network operator of terms and conditions of participation within the charity contribution propensity program.

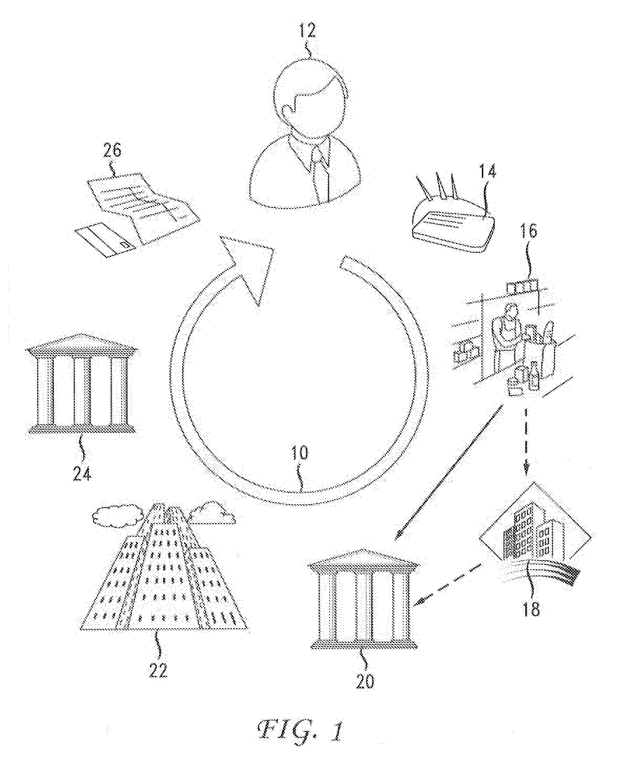

The process and parties typically involved in consummating a cashless payment transaction can be visualized for example as presented in FIG. 1, and can be thought of as a cycle, as indicated by arrow 10. A device holder 12 may present a payment device 14, for example a payment device, transponder device, NFC-enabled smart phone, among others and without limitation, to a merchant 16 as payment for goods and/or services. For simplicity the payment device 14 is depicted as a credit card, although those skilled in the art will appreciate the present disclosure is equally applicable to any cashless payment device, for example and without limitation, contactless RFID-enabled devices including smart cards, NFC-enabled smartphones, electronic mobile wallets or the like. The payment device 14 here is emblematic of any transaction device, real or virtual, by which the device holder 12 as payor and/or the source of funds for the payment may be identified.

In cases where the merchant 16 has an established merchant account with an acquiring bank (also called the acquirer) 20, the merchant communicates with the acquirer to secure payment on the transaction. An acquirer 20 is a party or entity, typically a bank, which is authorized by the network operator 22 to acquire network transactions on behalf of customers of the acquirer 20 (e.g., merchant 16). Occasionally, the merchant 16 does not have an established merchant account with an acquirer 20, but may secure payment on a transaction through a third-party payment provider 18. The third party payment provider 18 does have a merchant account with an acquirer 20, and is further authorized by the acquirer 20 and the network operator 22 to acquire payments on network transactions on behalf of sub-merchants. In this way, the merchant 16 can be authorized and able to accept the payment device 14 from a device holder 12, despite not having a merchant account with an acquirer 20.

The acquirer 20 routes the transaction request to the network operator 22. The data included in the transaction request will identify the source of funds for the transaction. With this information, the network operator 22 routes the transaction to the issuer 24. An issuer 24 is a party or entity, typically a bank, which is authorized by the network operator 22 to issue payment devices 14 on behalf of its customers (e.g., device holder 12) for use in transactions to be completed on the network. The issuer 24 also provides the funding of the transaction to the network provider 22 for transactions that it approves in the process described. The issuer 24 may approve or authorize the transaction request based on criteria such as a device holder's credit limit, account balance, or in certain instances more detailed and particularized criteria including transaction amount, merchant classification, etc., which may optionally be determined in advance in consultation with the device holder and/or a party having financial ownership or responsibility for the account(s) funding the payment device 14, if not solely the device holder 12.

The decision made by the issuer 24 to authorize or decline the transaction is routed through the network operator 22 and acquirer 20, ultimately to the merchant 16 at the point of sale. This entire process is typically carried out by electronic communication, and under routine circumstances (i.e., valid device, adequate funds, etc.) can be completed in a matter of seconds. It permits the merchant 16 to engage in transactions with a device holder 12, and the device holder 12 to partake of the benefits of cashless payment, while the merchant 16 can be assured that payment is secured. This is enabled without the need for a preexisting one-to-one relationship between the merchant 16 and every device holder 12 with whom they may engage in a transaction.

The issuer 24 may then look to its customer, e.g., device holder 12 or other party having financial ownership or responsibility for the account(s) funding the payment device 14, for payment on approved transactions, for example and without limitation, through an existing line of credit where the payment device 14 is a credit card, or from funds on deposit where the payment device 14 is a debit card. Generally, a statement document 26 provides information on the account of a device holder 12, including merchant data as provided by the acquirer 20 via the network operator 22.

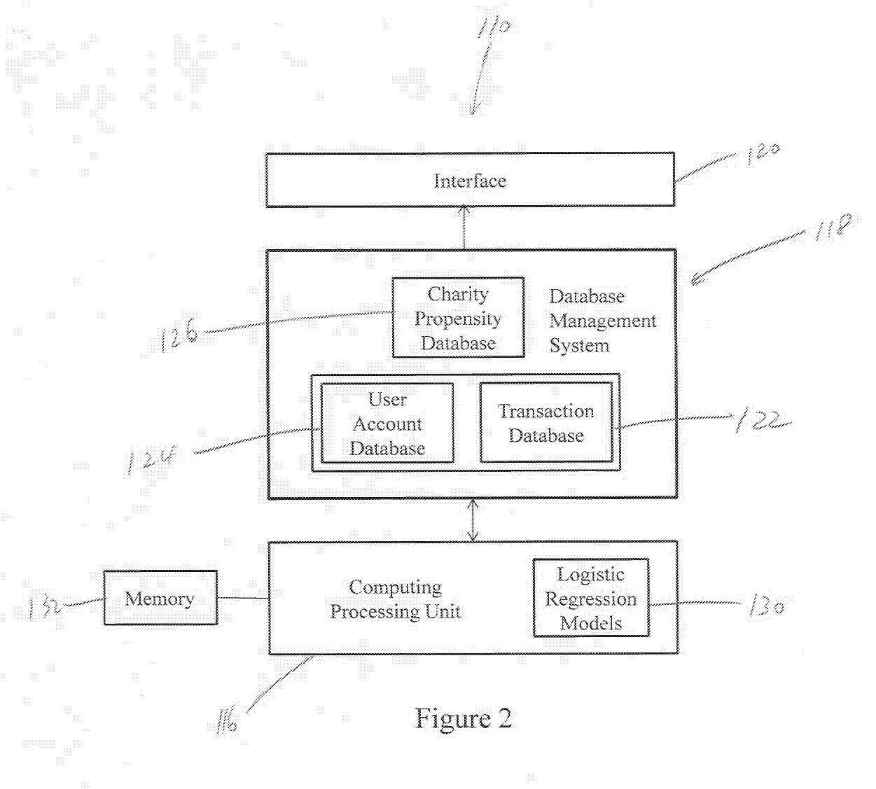

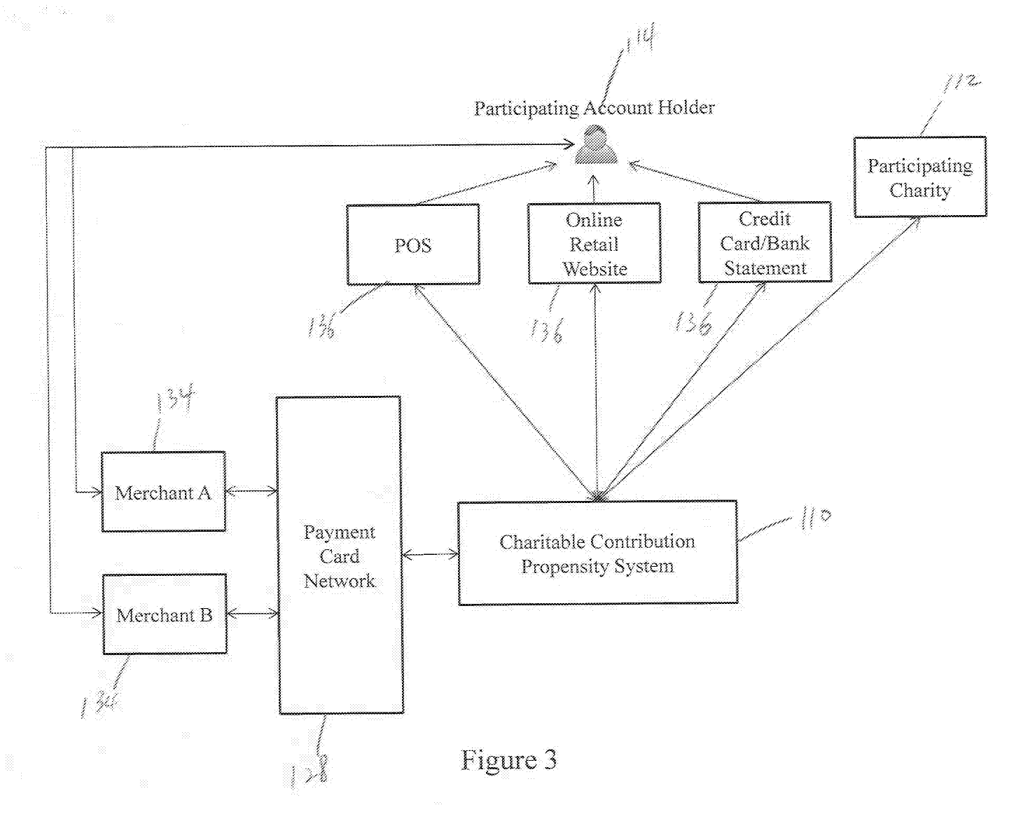

FIGS. 2 and 3 illustrate a system 110 for determining the propensity of candidate donors to donate to one or more charities, according to the present invention. The present invention leverages the cashless financial transaction data, which includes past purchases and past charitable contributions, of account holders to generate scores based on spending behaviors/patterns to evaluate propensity to donate, allowing charities to make informed decisions on soliciting donations from prospective donors.

The present invention provides several benefits to participating charities 112. More particularly, the present invention provides the participating charities 112 with convenient and accurate ways to target and attract prospective donors that are most likely to make donations. For example, an embodiment according to the present invention, the participating charities 112 can call or send solicitation materials only to the prospective donors with a high propensity score, thus reducing time and cost related to general solicitation calls and mailings and increasing the efficiency of their efforts to maintain and attract donors.

The present invention also provides benefits to participating account holders 114. More particularly, based on the participating account holders' 114 past spending patterns, as will be described in greater detail below, the present invention can provide a list of charities that the participating account holders 114 will most likely support in the future. Thus, the present invention can potentially help the participating account holders 114 by reducing the time and effort associated with searching for charities to support.

Referring again to FIGS. 2 and 3, the system 110 according to the present invention generally includes one or more computing processing units (CPUs) 116, one or more database management systems 118 and an interface 120. The one or more database management systems 118 are configured to manage a plurality of databases, including, but not limited to, a transaction database 122, a user account database 124 and a charity propensity database 126. Alternately, each of the plurality of databases 122, 124, 126 may be separately managed by individual database management systems 118.

The one or more CPUs 116 may include application-specific circuitry including the operative capability to execute the prescribed operations integrated therein, for example, an application specific integrated circuit (ASIC) and/or microprocessor. Each CPU 116 is operatively linked, hard wired and/or wirelessly, to the one or more payment device networks 128. The one or more CPUs 116 are configured to interface with the plurality of databases 122, 124, 126 in the database management system 118. The CPUs 116 are operative to act. on a program or set of instructions stored in the database management system 118. Execution of the program or set of instructions causes one of the CPUs 116 to carry out tasks such as locating data, retrieving data, processing data, etc. in addition, the one or more CPUs 116 can execute a plurality of logistic regression models 130, which are utilized to evaluate and analyze the financial transactions stored in the plurality of databases 122, 1.24, 126 to determine the propensity scores of each account holder. The plurality of logistic regression models 130 will be discussed in greater detail below.

The one or more CPUs 116 may further be configured to monitor financial transactions being transmitted over the one or more payment device networks 128. Little or no modification may be required to the payment device networks 128 to allow the CPUs 116 to review and collect the financial transactions. The one or more CPUs 116 may also be configured to identify financial transactions, which may be potentially relevant to determining propensity scores for each account holder. Once identified, the financial transactions may be stored in an electronic memory 132, which is operatively linked to the CPU 116. The electronic memory 132 may be provided at the same physical location (computing unit) as the CPU 116, and/or may be provided at a different location remote from the location of the CPU 116. The electronic memory 132 can include any combination of random access memory (RAM), read only memory (ROM), a storage device including a hard drive, or a portable, removable computer readable medium, such as a compact disk (CD) or a flash memory, or a combination thereof.

The transaction database 122 may be configured to store the financial transactions that are monitored and identified by the CPUs 116. More specifically, the ISO 8583 formatted data extracted from the financial transactions processed over the one or more payment device networks 128 may be stored and maintained in the transaction database 122. The ISO 8583 formatted data may be extracted by parsing the identified financial transactions. Furthermore, the transaction database 122 may be configured to store data structures from any data sources such as payment network device operator's data warehouses, data feeds from third-parties (e.g., issuers, acquirers, etc.).

The user account database 124 may be configured to store information associated with all account holders, including the participating account holders 114 of the charitable contribution propensity program. The user account database 124 may further be configured to store information related to the participating charities 112 of the charitable contribution propensity program. Examples of such information are name, address, phone number, charity type, etc. If an account holder desires to become a participant within the charitable contribution propensity program, the account holder can sign up for the program via the online registration or the customer service. Once the account holder completes the sign-up process, the account holder account is simply created by retrieving the relevant data associated with the account holder from the payment device network operator's customer account database and inserting the related data into the user account database 124.

A charity can also enroll with the charitable contribution propensity program. If the charity is an existing member of the payment device network operator, the procedure for enrolling the program is identical to the procedure described above. However, if the charity is not a member of the payment device network operator, charity details such as the name, address, charity category (public health, education, etc.) must be provided via the charitable contribution propensity program sign-up process. Thereafter, the required charity details are processed and stored in the user account database 124 to create an account. Once the charity is recognized as a participant of the charitable contribution propensity program, it can access highly qualified and targeted candidate donors, specifically tailored for the participating charity 112. Thus, the participating charity 112 can strategize on who they need to solicit, how much donation should be solicited, etc.

The charity propensity database 126 is configured to store data structures corresponding to a propensity profile of each account holder. The propensity profile may include data pertaining to charitable contribution propensity of an account holder including, but not limited to, charity categories, a propensity score for each of the charity categories and an anticipated charitable contribution amount for each of the charity categories, and so forth. The propensity profiles are generated using the plurality of logistic regression models 130.

The plurality of databases 122, 124, 128 may be configured with any type of database such as a relational database, a distributed database, an object database, an object-relational database, NoSQL database, etc. In addition, two or more of the databases 122, 124, 128 may be combined.

The system 110 may also include an interface 120 for communicating between one or more participants 112, 114 and the CPUs 116. The interface 120 may be operatively linked, hard-wired and/or wirelessly, with the participants 112, 114 through direct connections (hard wired, dial-in modem, wireless connection, and so forth) and/or through a network, such as a network of global computers (e.g., the Internet). The interface 120 may be configured to provide for outputting information to the participants 112, 114. More specifically, the interface 120 can provide a graphical user interface (GUI) configured to be displayed on a display device, printer-ready output, display-ready output, and/or audible output. For example, the interface 120 can display lists of candidate donors to the participating charities 112 via the GUI.

The interface 120 can be implemented as a stand-alone application on both a web-based platform (online/Internet web application) and mobile-based platform (mobile application) such that the participants 112, 114 may access it over the Internet using a computing device which includes a display and an input device implemented therein. Non-limiting examples of computing devices include a personal computer (laptop or desktop), mobile phone (smartphones), tablets, personal digital assistants (PDA), or other similar devices. The computer devices will typically access the system 110 directly through an Internet service provider (ISP) or indirectly through another network interface.

The CPUs 116 and the interface 120 are operatively linked to the one or more database management systems 118. The one or more database management systems 118 may be of any electronic, non-transitory form configured to manage the plurality of databases 122, 124, 126. The one or more database management systems 118 may reside on the same or different computing device from the CPUs 116. The database management system 118 may include MySQL, MariaDB, PostgreSQL, SQLite, Microsoft SQL Server, Oracle, SAP HANA, dBASE, FoxPro, IBM DB2, LibreOffice Base, FileMaker Pro, Microsoft Access and InterSystems Cache. All or a portion of the one or more database management system 118 may be maintained by a third party and/or configured as cloud storage.

Referring more particularly to FIG. 3, the system 110 operates in conjunction with the one or more payment device networks 128 with the capability to exchange data with the one or more payment device networks 128. As will be appreciated by those skilled in the art, any payment device network may be utilized, including traditional networks which communicate between merchants 134, acquirers, and issuers to authorize and clear consumer debit and credit transactions (e.g., Automated Clearing House (ACH) network). The subject invention may be also used with wireless systems which are configured to access traditional networks. Further, the subject invention may be used with other systems for authorizing and clearing debit and credit transactions via wireless devices such as smartphones or web-enabled applications.

As illustrated in FIG. 3, the participating account holder 114 and the participating charities 112 are the users of the system 110. The system 110, according to an embodiment of the present invention, is capable of providing lists of candidate donors and lists of suggested charities to the participating charities 112 and the participating account holders 114, respectively, via the system 110. The system 110, more specifically the interface 120, transmits the information to the participating charities 112 using methods that are prevalent in the relevant art, such as e-mail, SMS, applications (web-based or mobile device), etc. In addition, the participating account holders 114 may receive the information via a variety of different channels 136, such as the Internet, point-of-sale (POS), as will be described in more detail below.

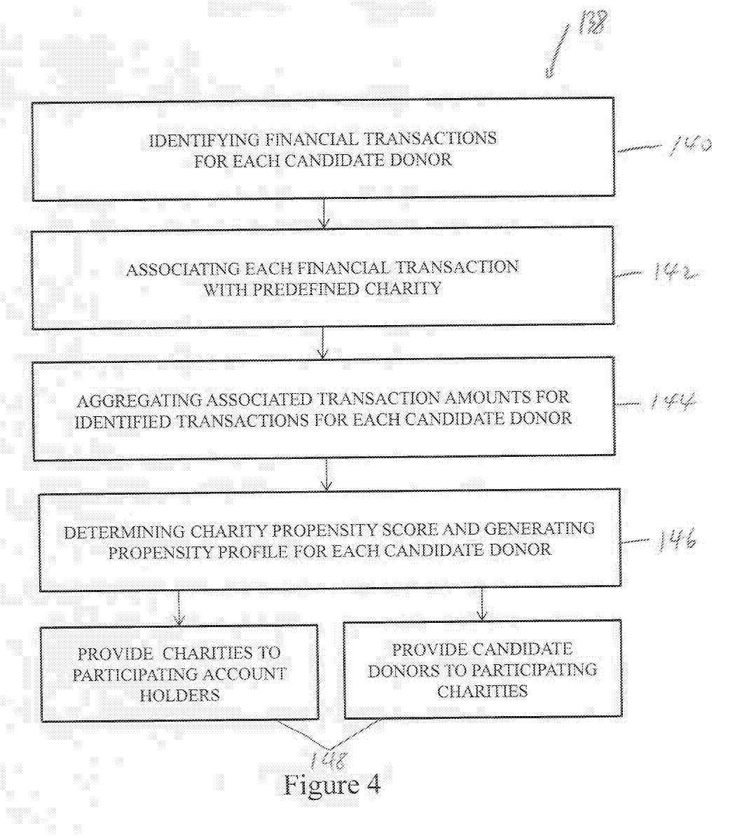

With reference to FIG. 4, a method 138 for determining the propensity of candidate donors to donate to one or more charities according to the present disclosure is described in the flowchart. The method 138 may be a real-time method that enables the system 110 to generate propensity scores of each account holder in an accurate and timely manner to provide lists of candidate donors and lists of suggested charities to the participating charities 112 and the participating account holders 114, respectively. For example, when an account holder makes a new donation to a charity using his/her payment device, new propensity scores will be generated (incorporating the new donation) and stored in the charity propensity database 126. Thereafter, lists of candidate donors and lists of suggested charities may be regenerated for all participants 112, 114.

In a first step 140, the one or more CPUs 116 monitor financial transactions over the payment device network 128 to identify the financial transactions (past purchases and past charitable contributions) that are associated with each candidate donor (or account holder) in the user account database 124, using account numbers stored in the user account database 124. The account numbers are transmitted as standard information in the identified financial transactions. Thereafter, the CPUs 116 parse the identified financial transactions related to each candidate donor to extract the ISO 8583 formatted data. The extracted ISO 8583 formatted data includes, but not limited to, transaction time, transaction date or purchase date, merchant name, merchant type and amount of good or service. Once all the identified financial transactions are parsed to extract the ISO 8583 formatted data, the data is processed and formatted to be stored in the transaction database 122.

In a second step 142, the financial transactions identified for each candidate donor in the first step 140 are utilized to determine each candidate donor's spending behaviors/patterns. More specifically, the parsed financial transactions are evaluated to determine various charity categories that the candidate donor may be interested in donating. For example, if a merchant category code or merchant name is embedded in a financial transaction within the ISO 8583 information that is associated with the candidate donor, a charity category for the candidate donor may be determined by comparing the merchant category code and/or merchant name with the predefined charities. Also, using the merchant category code or merchant name embedded in the ISO 8583 information, each of the parsed financial transactions may also be associated with one of the predefined charities. Examples of charity categories are environmental, public health, animal welfare, education, art, social welfare, culture, etc.

In a third step 144, once each of the parsed financial transactions is determined as being associated with one of the predefined charities, the attributes that are required to determine propensity scores for each of the candidate donors, as will be describe in more detail below, are generated. For example, the associated transaction amounts for each of the parsed financial transactions for the candidate donor associated with each predefined charity are aggregated to determine the total amount for each predefined charity. In addition, the total spending amount for the candidate donor is computed by aggregating the transaction amount of each parsed financial transactions.

This aggregation process is illustrated with the following hypothetical example: Consider a candidate donor with the following five financial transactions (past purchases). Transaction 1 is associated with “Environmental” with a transaction amount of $25. Transaction 2 is associated with “Public Health” with a transaction amount of $40. Transaction 3 is associated with “Environmental” with a transaction amount of $50. Transaction 4 is associated with “Environmental” with a transaction amount of $10. Transaction 5 is associated with “Public Health” with a transaction amount of $100. Thus, in this hypothetical example, once the aggregation process in the third step 144 is performed, the aggregated attributes (outputs) of the charity category of “Environmental” with an aggregated transaction amount of $85, the charity category of “Public Health” with an aggregated transaction amount of $140 and the total spending amount of $225 would be generated.

In a fourth step 146, the plurality of logistic regression models (statistical techniques) 130 are used to generate a propensity profile for each candidate donor. As described above, the propensity profile may include data pertaining to charitable contribution propensity of a candidate donor such as overall charitable propensity score, charity categories, propensity scores for each of the charity categories, anticipated total charitable contribution amount and anticipated charitable contribution amounts for each of the charity categories, and so forth. The plurality of logistic regression models 130 perform statistical algorithms or sets of instructions or operations on the data stored in the databases 122, 124, 126. Algorithms used in the logistic regression models 130 are based on statistical models of account holders' spending behaviors to generate propensity scores. The logistic regression models 130 can be designed with mathematical-based methods, rules-based methods and machine learning-based methods. The logistic regression models 130 evaluate the data produced during the second and third steps 142, 144 above and assign a propensity score to the candidate donor based on the aggregated transaction amounts associated with each of the charity categories relative to the aggregated transaction amount, or total spending amount, for the candidate donor. The propensity score represents likelihood of the candidate donor to donate to charities in the corresponding charity category. In other words, a higher propensity score implies a greater propensity to donate. Once the propensity profiles are generated, they may be stored in the charity propensity database 126.

In an alternate embodiment, the propensity score may be determined by analyzing the candidate donor's aggregated transaction amounts associated with each of the charity categories against a plurality of “model donors”, which are generated by the logistic regression models 130 based on historical spending/charitable contribution patterns of all customers. For example, based on historical data, the logistic regression models 130 may determine that 5% of customers that spend between $100 and $200 on groceries donate to various charities, with the median charitable contribution amount being $5 and the average charitable contribution amount being $2 with 90% of charitable contribution amounts falling between $1 and $20. Amongst the donors, 75% donated to “Social Service Organizations”, 20% to “Political Organizations” and 10% to “Religious Organizations”. Similarly, the logistic regression models 130 may identify that 2% of customers that spend between $50 and $100 on groceries donate to various charities, with the median charitable contribution amount being $1 and the average charitable contribution amount being $0.75 with 90% of charitable contribution amounts falling between $1 and $20. Amongst the donors, 65% donated to “Social Service Organizations”, 25% to “Political Organizations” and 10% to “Religious Organizations”. Accordingly, if the candidate donor spends $75 on the groceries, the propensity score and anticipated charitable contribution amount for each of the categories (“Social Service”, “Politics” and “Religion”) can be determined using a plurality of predetermined “model donors”.

The propensity score may be provided as a number, letter, color, and combinations thereof, of a scale extending from a high likelihood to donate to a low likelihood to donate. It is important to note that the propensity score provides no personal details relating to the financial transactions. Rather, the propensity score is a representation of the likelihood of a charitable contribution behavior by the candidate donor in order to preserve the candidate donor's privacy.

In addition, the anticipated total charitable contribution amount and anticipated charitable contribution amounts for each of the charity categories may be determined by applying attributes (such as frequency of donation, amount per donation, average amount per donation, etc.) to the plurality of logistic regression models 130.

It is noted that not all candidate donors will have adequate number of identified financial transactions to determine a valid propensity score. For those candidate donors, no propensity score will be generated, as the generated propensity score will be suspect in its accuracy. In addition, not all candidate donors will have the identified financial transactions that are associated with past charitable contributions since not all candidate donors donate. For those candidate donors, charity categories and the propensity score associated with each of the charity categories will be generated with only the identified financial transactions of past purchases that are associated with charity categories. For example, if an account holder spends about 50% of total monthly spending on buying books and 30% of total monthly spending on going to plays, a propensity score for each charity category of “Education” and “Art” may be determined using only the identified financial transactions that are characterized as past purchases.

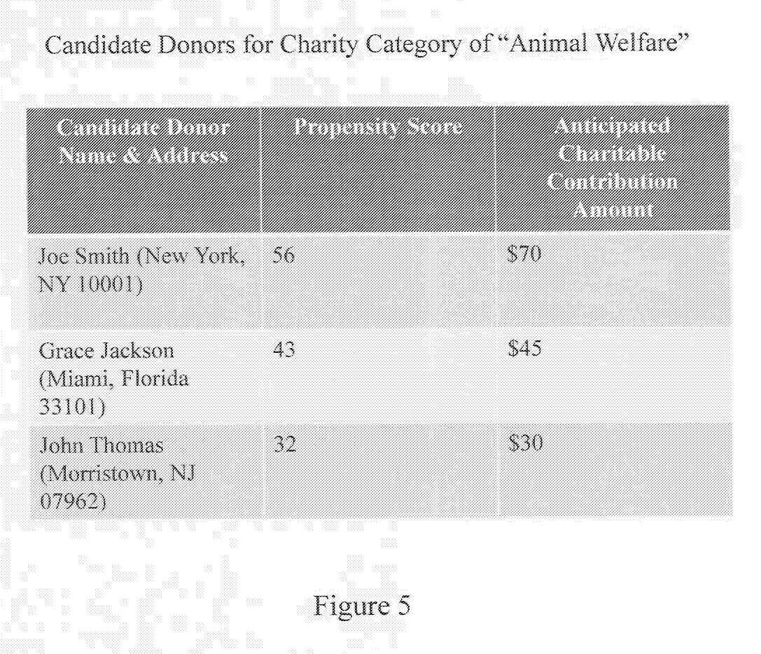

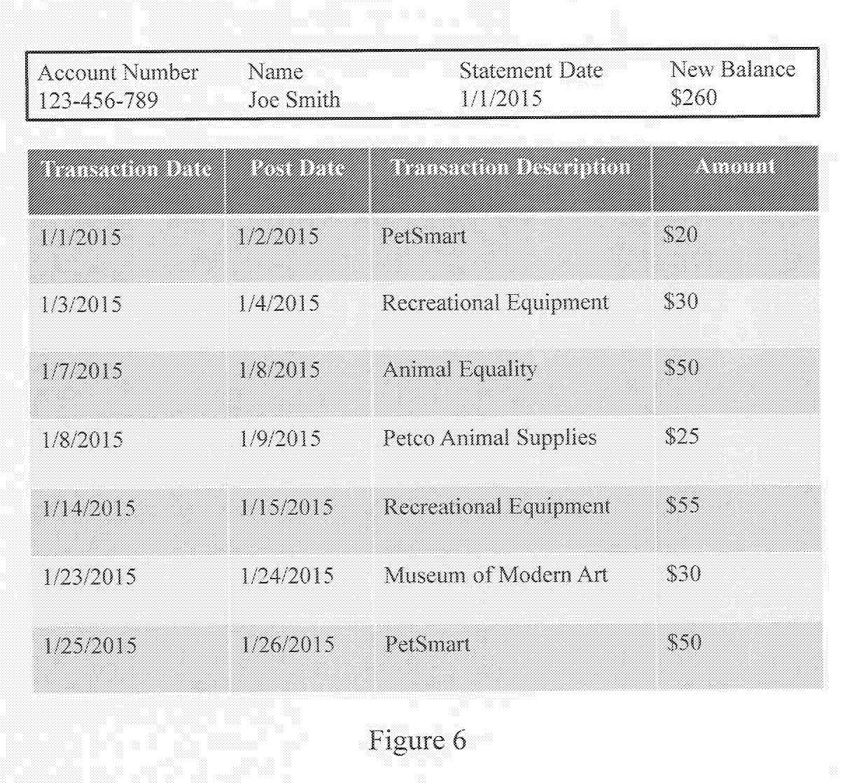

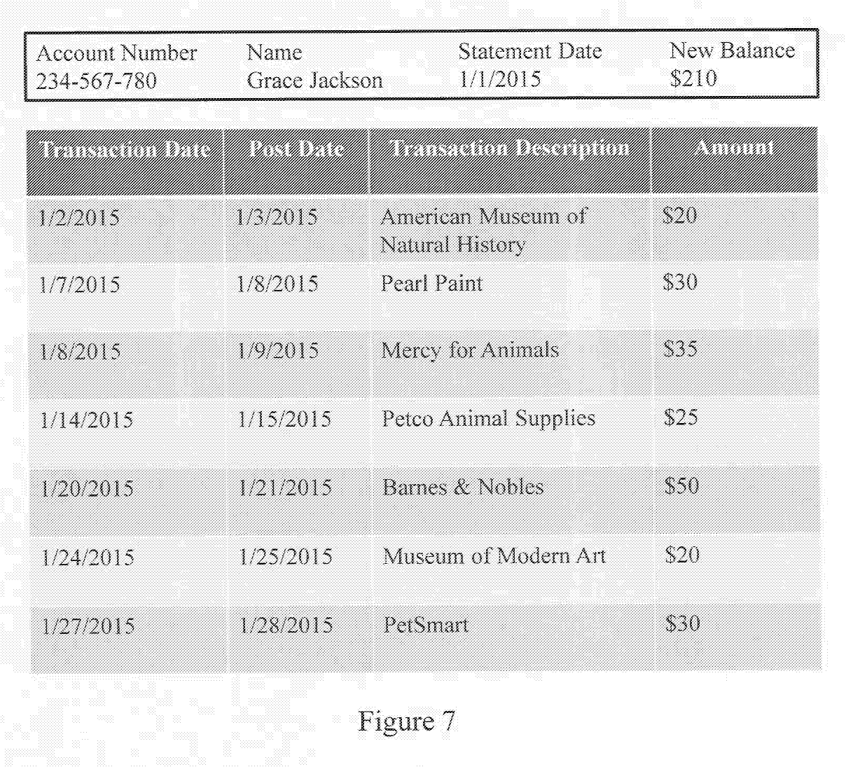

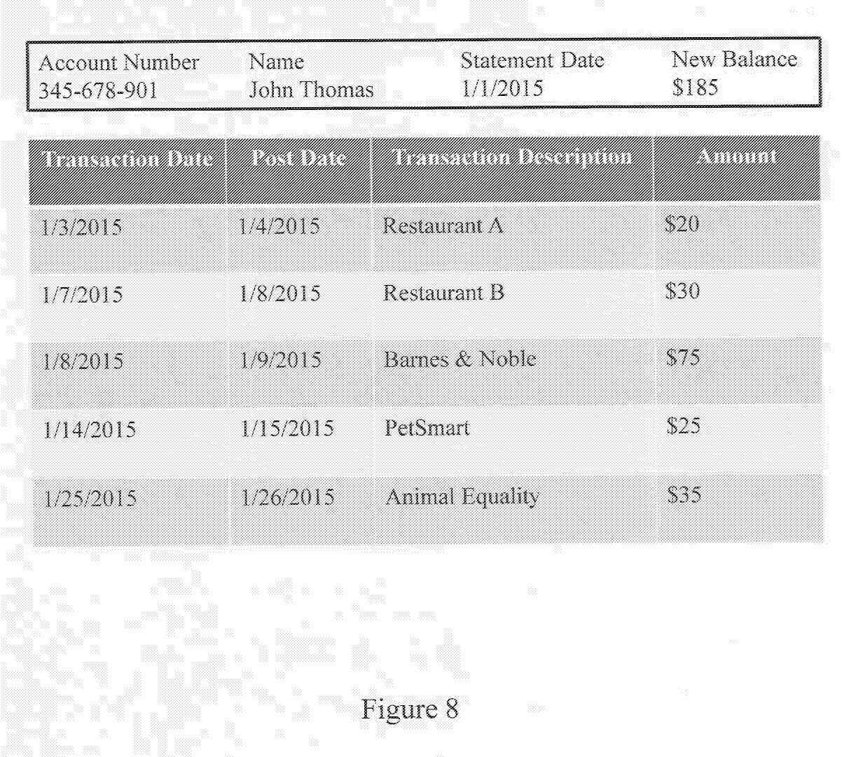

FIG. 5 displays an exemplary list of candidate donors for a charity category of “Animal Welfare”, in accordance with the present invention. Each candidate donor in the list has a propensity score in the “Animal Welfare” charity category that exceeds a predetermined threshold propensity score for the “Animal Welfare” charity category. The propensity scores of the candidate donors displayed in FIG. 5 are generated based on the candidate donors' financial transactions included in the exemplary credit card statements as illustrated in FIGS. 6, 7 and 8. A higher propensity score implies a greater propensity to donate the anticipated charitable contribution amount to the charities that support animal welfare activities.

FIGS. 6, 7 and 8 list the financial transactions for “Joe Smith”, “Grace Jackson” and “John Thomas”, respectively. Using the second 142 and third 144 steps, the aggregated amounts associated with “Animal Welfare” for the candidate donors, “Joe Smith”, “Grace Jackson” and “John Thomas”, can be computed, and are $145, $90 and $60, respectively. The total spending amounts for “Joe Smith”, “Grace Jackson” and “John Thomas” are $260, $210 and $185, respectively. Based on these outputs, “Joe Smith” spent 56% ($145÷$260) of his total spending on “Animal Welfare”, whereas “John Thomas” spent only 32% ($60÷$185) on “Animal Welfare”. Thus, in this example as shown in FIG. 5, the account holders with the highest propensity score and lowest propensity score are “Joe Smith” and “John Thomas”, respectively, suggesting that, of the three, “Joe Smith” will most likely donate and John Thomas will least likely donate to the charities that support animal welfare activities. Accordingly, the participating charities 112 in “Animal Welfare” may target “Joe Smith” first to solicit for donation before targeting “John Thomas”.

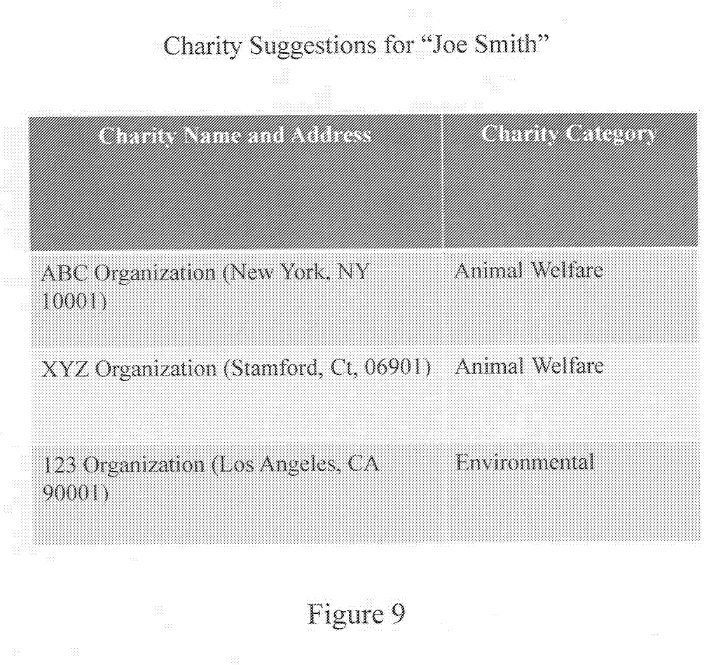

Referring to FIG. 9, a table with an exemplary list of suggested charities for a participating account holder 114, in this example “Joe Smith”, is shown. The predetermined threshold propensity score of each charity category in the list is below the propensity score of each corresponding charity category of the participating account holder 114, “Joe Smith”. The list includes charity name and address and a charity category with respect to each suggested charity. In this example, based on the transactions listed on FIG. 6, the propensity scores for various charity categories of “Joe Smith” have determined that he will most likely donate to charities in “Animal Welfare” and “Environment”.

Referring again to FIG. 4, in a fifth step 148, a participating account holder 114 may receive a list of suggested charities via a variety of different channels 136. First, the participating account holder 114 may receive the list via the Internet. The participating account holder 114 may use his/her phone, tablet or computer to shop at a web-based retailer. When the participating account holder 114 inputs information associated with his/her payment device and is ready to check out from the merchant's website, the list of suggested charities associated with the participating account holder's 114 spending patterns is retrieved from the charity propensity database 126 via a merchant application program interface and is displayed on the merchant's checkout webpage. If the account holder desires to make a donation, the account holder can simply select one or more charities from the list. Thereafter, the transaction, including donations, proceeds in customary fashion.

The list of suggested charities for the participating account holder 114 can also be delivered during retail purchase transactions via a dynamic POS system. Normally, in a retail store, once the participating account holder 114 completes the shopping, and the clerk scans all items, the participating account holder 114 swipes his/her payment device to proceed with an authorization process. Thereafter, the account holder needs to sign on the signature pad screen to complete the transaction. With the present invention, after the participating account holder 114 swipes the payment device, the list of suggested charities may be displayed on the signature pad screen to allow the participating account holder 114 an option to donate in one or more charities in a private way. If the participating account holder 114 desires to make a donation, the account holder can simply select one or more charities from the list displayed on the signature screen pad. Thereafter, the transaction, including the donation, is completed by signing on the signature pad screen.

The list of suggested charities for the participating account holder 114 may also be provided via mail, more specifically, as part of mailed credit card/bank statements. Normally, the participating account holder 114 receives a monthly credit card/bank statement that includes records of past month purchase transactions by mail, unless the account holder has indicated “paperless” to the card issuer/bank. The list of suggested charities and donation forms may be included along the statement to allow the participating account holder 114 to contribute. For example, if the participating account holder 114 wishes to make a donation, the account holder simply needs to complete the donation form by providing contact information and payment information, and mail the completed donation form, with the donation, to the charity.

It will be appreciated by the one skilled in the art that the delivery modes of suggested charities for the participating account holders 114 are not limited to the aforementioned channels. Additional delivery modes may be implemented via other available channels.

In addition, as stated above, a list of candidate donors may be delivered to a participating charity 112 via methods that are prevalent in the relevant art, such as e-mail, SMS, applications (web-based or mobile device), etc.

What is claimed is:

1. A method for determining the propensity of candidate donors to donate to one or more charities, the method comprising:
operatively linking a computing processing unit to at least one payment device network;
operatively linking an electronic memory to the computing processing unit;
identifying, using the computing processing unit, transactions processed over the at least one payment device network as being associated with a first candidate donor;
storing the identified transactions on the electronic memory;
parsing the identified transactions to extract ISO 8583 formatted data, the ISO 8583 formatted data representing, where present, for each of the identified transactions,
an associated merchant category code, an associated merchant name, and an associated transaction amount;
determining, for each of the identified transactions, where the associated merchant category code is present, if the associated merchant category code is associated with a first predefined charity to establish the respective identified transaction as being associated with the first predefined charity;
determining, for each of the identified transactions, where the associated merchant name is present, if the associated merchant name is associated with the first predefined charity to establish the respective identified transaction as being associated with the first predefined charity;
aggregating the associated transaction amounts for the identified transactions for the first candidate donor associated with the first predefined charity;
aggregating the associated transaction amounts for the identified transactions for the first candidate donor; and
assigning a propensity score to the first candidate donor based on the aggregated associated transaction amounts associated with the first predefined charity relative to the aggregated associated transaction amounts for the first candidate donor, the propensity score representing the propensity of the first candidate donor to donate to the first predefined charity.

2. The method of claim 1, wherein the identified transactions include past purchases and past charitable contributions of the first candidate donor.

3. The method of claim 1, wherein the propensity score is generated by a plurality of logistic regression models.

4. The method of claim 1, further comprising assigning an anticipated charitable contribution amount to the first candidate donor based on the aggregated associated transaction amounts associated with the first predefined charity relative to the aggregated associated transaction amounts for the first candidate donor, the anticipated charitable contribution amount representing a likely donation by the first candidate donor to the first predefined charity.

5. The method of claim 4, wherein the anticipated charitable contribution amount is generated by the plurality of logistic regression models.

6. The method of claim 1, further comprising comparing the propensity score of the first candidate donor to a predetermined threshold propensity score of the first predefined charity, and, if the propensity score of the first candidate donor is equal to or greater than the predetermined threshold propensity, delivering one or more details to the first predefined charity relating to the first candidate donor.

7. The method of claim 6, wherein the delivery of the one or more details to the first predefined charity is via e-mail, SMS, web-based applications and/or mobile applications.

8. The method of claim 1, further comprising comparing the propensity score of the first candidate donor to a predetermined threshold propensity score of the first predefined charity, and, if the propensity score of the first candidate donor is equal to or greater than the predetermined threshold propensity, delivering one or more details to the first candidate donor relating to the first predefined charity.

9. The method of claim 8, wherein the first predefined charity is recommended to the first candidate donor during purchases at point-of-sale terminals, during online purchases or as a part of credit card or bank account statements.

10. The method of claim 1, wherein the transactions are monitored in real time over the at least one payment device network by the computing processing unit so as to be identified in real time.

11. The method of claim 10, wherein the propensity score is updated in response to real time monitoring of the at least one payment device network.

12. A non-transitory machine-readable storage medium, having thereon a program of instruction which, when executed by a computing processing unit with an electronic memory, linked to at least one payment device network, cause the computing processing unit to:
identify transactions processed over the at least one payment device network as being associated with a first candidate donor;
store the identified transactions on the electronic memory;
parse the identified transactions to extract ISO 8583 formatted data, wherein the ISO 8583 formatted data represents, where present, for each of the identified transactions, an associated merchant category code, an associated merchant name, and an associated transaction amount;
determine, for each of the identified transactions, where the associated merchant category code is present, if the associated merchant category code is associated with a first predefined charity to establish the respective identified transaction as being associated with the first predefined charity;
determine, for each of the identified transactions, where the associated merchant name is present, if the associated merchant name is associated with the first predefined charity to establish the respective identified transaction as being associated with the first predefined charity;
aggregate the associated transaction amounts for the identified transactions for the first candidate donor associated with the first predefined charity;
aggregate the associated transaction amounts for the identified transactions for the first candidate donor; and
assign a propensity score to the first candidate donor based on the aggregated associated transaction amounts associated with the first predefined charity relative to the aggregated associated transaction amounts for the first candidate donor, the propensity score representing the propensity of the first candidate donor to donate to the first predefined charity.

13. The medium according to claim 12, wherein the identified transactions include past purchases and past charitable contributions of the first candidate donor.

14. The medium according to claim 12, wherein the propensity score is generated by a plurality of logistic regression models.

15. The medium according to claim 12, further causing the computing processing unit to assign an anticipated charitable contribution amount to the first candidate donor based on the aggregated associated transaction amounts associated with the first predefined charity relative to the aggregated associated transaction amounts for the first candidate donor, the anticipated charitable contribution amount representing a likely donation by the first candidate donor to the first predefined charity.

16. The medium according to claim 15, wherein the anticipated charitable contribution amount is generated by the plurality of logistic regression models.

17. The medium according to claim 12, further causing the computing processing unit to compare the propensity score of the first candidate donor to a predetermined threshold propensity score of the first predefined charity, and wherein, with the propensity score of the first candidate donor being equal to or greater than the predetermined threshold propensity, delivering one or more details to the first predefined charity relating to the first candidate donor.

18. The medium according to claim 17, wherein the delivery of the one or more details to the first predefined charity is via e-mail, SMS, web-based applications and/or mobile applications.

19. The medium according to claim 11, further causing the computing processing unit to compare the propensity score of the first candidate donor to a predetermined threshold propensity score of the first predefined charity, and wherein, with the propensity score of the first candidate donor being equal to or greater than the predetermined threshold propensity, delivering one or more details to the first candidate donor relating to the first predefined charity.

20. The medium according to claim 19, wherein the first predefined charity is recommended to the first candidate donor during purchases at point-of-sale terminals, during online purchases or as a part of credit card or bank account statements.

21. The medium according to claim 11, wherein the transactions are monitored in real time over the at least one payment device network by the computing processing unit so as to be identified in real time.

22. The medium according to claim 21, wherein the propensity score is updated in response to real time monitoring of the at least one payment device network.

23. A system for determining the propensity of candidate donors to donate to one or more charities, the system comprising:
one or more computing processing units configured to monitor financial transactions being transmitted over one or more payment device networks and to execute a plurality of logistic regression models;
an electronic memory linked to the one or more computing processing units;
one or more database management systems, each of the one or more database management systems including:
a user account database configured to store data associated with account holders, including participating account holders and participating charities,
a transaction database configured to store financial transactions identified by the one or more computing processing units, the identified financial transaction including past purchase details and past charitable contribution details, and
a charity propensity database configured to store data structures corresponding to a propensity profile, including propensity scores, for each of the account holders; and
an interface configured to communicate between the participants and the one or more computing processing units.
